(19) United States
(12) Patent Application Publication
(10) Pub. No.: US 2022/0292177 A1
(43) Pub. Date: Sep. 15, 2022

(54) METHOD AND SYSTEM FOR CONTROLLING ACCESS TO SECURITY CREDENTIAL IN CONTINUOUS INTEGRATION / CONTINUOUS DEPLOYMENT PIPELINE

(71) Applicant: JPMorgan Chase Bank, N.A., New York, NY (US)

(72) Inventors: Adrian ASHER, Jersey City, NJ (US); Vladislav KAIPETSKIY, Glasgow (GB)

(73) Assignee: JPMorgan Chase Bank, N.A., New York, NY (US)

(21) Appl. No.: 17/201,923

(22) Filed: Mar. 15, 2021

(51) Int. Cl. G06F 21/44; G06F 11/36; G06F 8/10; G06F 9/54

(52) U.S. Cl. CPC G06F 21/44; G06F 11/3688; G06F 8/10; G06F 9/547; G06F 2221/2141

(57) ABSTRACT

Methods and systems for controlling and governing access to a security credential are provided. A method includes: receiving a first set of software code; testing the first set of code; receiving a certification that the first set of code has passed a compliance posture of an organization; requesting, from a credential source, either a credential that indicates that the certification has been received and/or an authorization to use the credential; and when the credential and/or the authorization to use the credential has been received, deploying the first set of software code in a predetermined destination and/or modifying the configuration of a controlled destination system. The method may be implemented in a continuous integration/continuous deployment (CI/CD) pipeline environment.

### BACKGROUND

### 1. Field of the Disclosure

This technology generally relates to methods and systems for controlling authorization to deploy as part of the software development processes, and more particularly, to methods and systems for controlling access to a security credential in a continuous integration/continuous deployment (CI/CD) pipeline in a manner designed to ensure secure operations while optimizing agility and efficiency.

### 2. Background Information

DevOps is a set of practices that combines software development (“Dev”) with information technology (IT) operations (“Ops”). In recent times, DevOps has been widely adopted as a modern methodology that enables software developers to quickly and iteratively generate software code that is deployed to production. However, with the speed, there is an increase in risk to the governance and oversight of the process that covers the deployment of application to production. Historically, the traditional practice has been to have one team that generates the code and another team that reviews and deploys the code. This introduces latency and bureaucracy into the processes. In this aspect, DevOps facilitates more flexible deployment practices by allowing the same teams to perform both the code generation and the deployment to production.

In order for regulatory and control requirements to be satisfied, there must still be controls and approvals as part of the Software Development Lifecycle (SDLC). These controls and approvals generally improve the quality of the deployable object and are therefore a good thing.

Accordingly, there is a need for a mechanism that preserves the controls and approvals and other governance needs with the objectives of increased speed, agility, and efficiency.

In conventional deployment models, there has been a segregation of duties between teams that create software and teams that deploy the software, such that it could be said that no developer has access to production. With the advent of DevOps, this has now changed. With this technology, it is possible to maintain segregation of duties while allowing for development teams to release software as often as desired. In this regard, governance need not be performed by a human in order to ensure governance of the software.

### SUMMARY

The present disclosure, through one or more of its various aspects, embodiments, and/or specific features or sub-components, provides, inter alia, various systems, servers, devices, methods, media, programs, and platforms for controlling access to a security token or credential in a continuous integration/continuous deployment (CI/CD) pipeline in a manner designed to ensure secure operations while optimizing agility and efficiency.

According to an aspect of the present disclosure, a method for controlling access to a security credential or token is provided. The method is implemented by at least one processor. The method includes: receiving, by the at least one processor from a user, a first set of software code; testing, by the at least one processor, the first set of code; receiving, by the at least one processor, a certification that the first set of code has passed at least one test; requesting, by the at least one processor from a credential source, at least one from among a credential that indicates that the certification has been received and an authorization to use the credential; and when the at least one from among the credential and the authorization to use the credential has been received, deploying, by the at least one processor, the first set of software code in a predetermined destination.

The method may be implemented in a continuous integration/continuous deployment (CI/CD) pipeline environment.

The testing may include subjecting the first set of software code to a unit test designed to determine whether the first set of software successfully performs a predetermined function.

The testing may include subjecting the first set of software code to a regulatory test designed to determine whether the first set of software complies with a predetermined governmental regulation.

The testing may include subjecting the first set of software code to a quality test designed to determine whether the first set of software satisfies a predetermined quality standard that is measurable by using at least one metric.

The testing may include subjecting the first set of software code to a security test designed to determine whether the first set of software complies with a predetermined security standard that relates to protecting the first set of software code from an external intrusion.

The credential may include at least one from among a security token, a key, and a signed object.

The authorization to use the credential may include a claim that proves that the user has access to the credential.

The predetermined destination may include an application programming interface (API).

According to another aspect of the present disclosure, a computing apparatus for controlling access to a security credential is provided. The computing apparatus includes a processor, a memory, and a communication interface coupled to each of the processor and the memory. The processor is configured to: receive, from a user, a first set of software code; test the first set of code; receive a certification that the first set of code has passed at least one test; request, from a credential source, at least one from among a credential that indicates that the certification has been received and an authorization to use the credential; and when the at least one from among the credential and the authorization to use the credential has been received, deploy the first set of software code in a predetermined destination.

The processor may be further configured to perform each of the receiving of the first set of software code, the testing, the receiving of the certification, the requesting, and the deploying in a continuous integration/continuous deployment (CI/CD) pipeline environment.

The processor may be further configured to subject the first set of software code to a unit test designed to determine whether the first set of software successfully performs a predetermined function.

The processor may be further configured to subject the first set of software code to a regulatory test designed to determine whether the first set of software complies with a predetermined governmental regulation.

The processor may be further configured to subject the first set of software code to a quality test designed to determine whether the first set of software satisfies a predetermined quality standard that is measurable by using at least one metric.

The processor may be further configured to subject the first set of software code to a security test designed to determine whether the first set of software complies with a predetermined security standard that relates to protecting the first set of software code from an external intrusion.

The credential may include at least one from among a security token, a key, and a signed object.

The authorization to use the credential may include a claim that proves that the user has access to the credential.

The predetermined destination may include an application programming interface (API).

According to another exemplary embodiment, a non-transitory computer readable storage medium storing instructions for controlling access to a security credential is provided. The storage medium includes executable code which, when executed by a processor, causes the processor to: receive, from a user, a first set of software code; test the first set of code; receive a certification that the first set of code has passed at least one test; request, from a credential source, at least one from among a credential that indicates that the certification has been received and an authorization to use the credential; and when the at least one from among the credential and the authorization to use the credential has been received, deploy the first set of software code in a predetermined destination.

The processor may be further configured to perform each of the receiving of the first set of software code, the testing, the receiving of the certification, the requesting, and the deploying in a continuous integration/continuous deployment (CI/CD) pipeline environment.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates an exemplary computer system.

FIG. 2 illustrates an exemplary diagram of a network environment, which may span multiple control domains, including on-premise, cloud, third party, or other trust zones.

FIG. 3 shows an exemplary system for implementing a method for controlling access to a security credential in a CI/CD pipeline in a manner designed to ensure secure operations while optimizing agility and efficiency.

FIG. 4 is a flowchart of an exemplary process for implementing a method for controlling access to a security credential in a CI/CD pipeline in a manner designed to ensure secure operations while optimizing agility and efficiency.

FIG. 5 is a diagram that illustrates a sequence of data flows during a code deployment process, in accordance with an exemplary embodiment.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

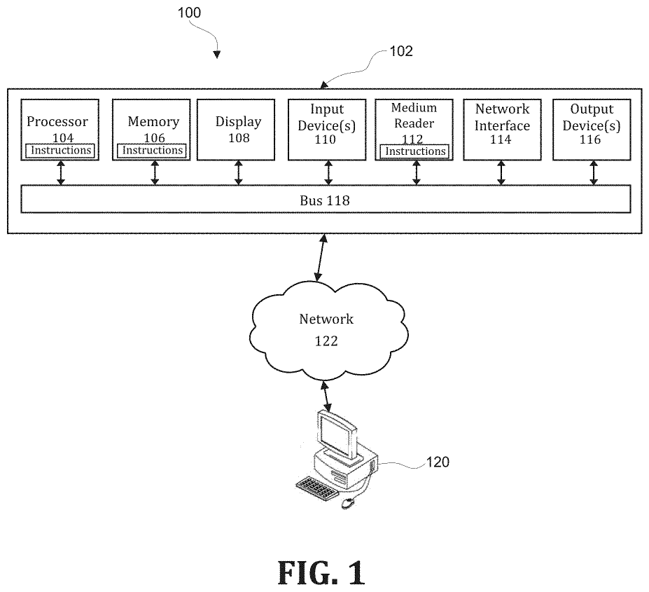

FIG. 1 is an exemplary system for use in accordance with the embodiments described herein. The system 100 is generally shown and may include a computer system 102, which is generally indicated.

The computer system 102 may include a set of instructions that can be executed to cause the computer system 102 to perform any one or more of the methods or computer based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data and executable instructions, and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, blu-ray disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid state display, a cathode ray tube (CRT), a plasma display, or any other type of display, examples of which are well known to skilled persons.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g. software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software or any combination thereof which are commonly known and understood as being included with or within a computer system, such as, but not limited to, a network interface 114 and an output device 116. The output device 116 may be, but is not limited to, a speaker, an audio out, a video out, a remote control output, a printer, or any combination thereof.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionality as described herein, and a processor described herein may be used to support a virtual processing environment.

As described herein, various embodiments provide optimized methods and systems for controlling access to a security credential in a CI/CD pipeline in a manner designed to ensure secure operations while optimizing agility and efficiency.

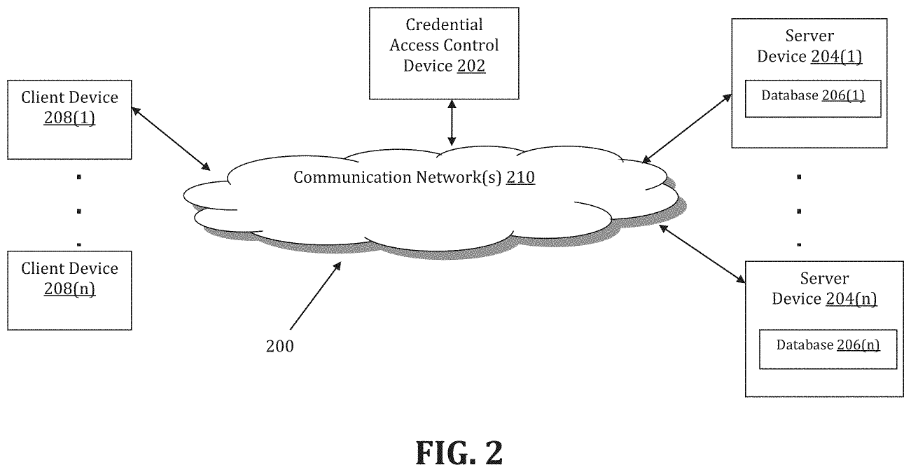

Referring to FIG. 2, a schematic of an exemplary network environment 200 for implementing a method for controlling access to a security credential in a CU/CD pipeline in a manner designed to ensure secure operations while optimizing agility and efficiency is illustrated. In an exemplary embodiment, the method is executable on any networked computer platform, such as, for example, a personal computer (PC).

The method for controlling access to a security credential in a CI/CD pipeline in a manner designed to ensure secure operations while optimizing agility and efficiency may be implemented by a Credential Access Control (CAC) device 202. The CAC device 202 may be the same or similar to the computer system 102 as described with respect to FIG. 1. The CAC device 202 may store one or more applications that can include executable instructions that, when executed by the CAC device 202, cause the CAC device 202 to perform actions, such as to transmit, receive, or otherwise process network messages, for example, and to perform other actions described and illustrated below with reference to the figures. The application(s) may be implemented as modules or components of other applications. Further, the application(s) can be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. The cloud-based computing environment may be hosted on third party hardware or on premise, or some combination thereof. Multiple third parties may also provide the virtual machines. Also, the application(s), and even the CAC device 202 itself, may be located in virtual server(s) running in a cloud-based computing environment rather than being tied to one or more specific physical network computing devices. Also, the application(s) may be running in one or more virtual machines (VMs) executing on the CAC device 202. Additionally, in one or more embodiments of this technology, virtual machine(s) running on the CAC device 202 may be managed or supervised by a hypervisor.

In the network environment 200 of FIG. 2, the CAC device 202 is coupled to a plurality of server devices 204(1)-204(n) that hosts a plurality of databases 206(1)-206(n), and also to a plurality of client devices 208(1)-208(n) via communication network(s) 210. A communication interface of the CAC device 202, such as the network interface 114 of the computer system 102 of FIG. 1, operatively couples and communicates between the CAC device 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the CAC device 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein. This technology provides a number of advantages including methods, non-transitory computer readable media, and CAC devices that efficiently implement a method for controlling access to a security credential in a CI/CD pipeline in a manner designed to ensure secure operations while optimizing agility and efficiency.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The CAC device 202 may be a standalone device or integrated with one or more other devices or apparatuses, such as one or more of the server devices 204(1)-204(n), for example. In one particular example, the CAC device 202 may include or be hosted by one of the server devices 204(1)-204(n), and other arrangements are also possible. Moreover, one or more of the devices of the CAC device 202 may be in a same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the DPP device 202 via the communication network(s) 210 according to the HTTP-based and/or JavaScript Object Notation (JSON) protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store information relating to controls, approvals, and governance with respect to software development and deployment, and credential data, including security tokens, passwords, and other types of user-specific security data.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. For example, the client devices 208(1)-208(n) in this example may include any type of computing device that can interact with the CAC device 202 via communication network(s) 210. Accordingly, the client devices 208(1)-208(n) may be mobile computing devices, desktop computing devices, laptop computing devices, tablet computing devices, virtual machines (including cloud-based computers), or the like, that host chat, e-mail, or voice-to-text applications, for example. In an exemplary embodiment, at least one client device 208 is a wireless mobile communication device, i.e., a smart phone.

The client devices 208(1)-208(n) may run interface applications, such as standard web browsers or standalone client applications, which may provide an interface to communicate with the CAC device 202 via the communication network(s) 210 in order to communicate user requests and information. The client devices 208(1)-208(n) may further include, among other features, a display device, such as a display screen or touchscreen, and/or an input device, such as a keyboard, for example.

Although the exemplary network environment 200 with the CAC device 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the CAC device 202, the server devices 204(1)-204(n), or the client devices 208(1)-208(n), for example, may be configured to operate as virtual instances on the same physical machine. In other words, one or more of the CAC device 202, the server devices 204(1)-204(n), or the client devices 208(1)-208(n) may operate on the same physical device rather than as separate devices communicating through communication network(s) 210. Additionally, there may be more or fewer CAC devices 202, server devices 204(1)-204(n), or client devices 208(1)-208(n) than illustrated in FIG. 2.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

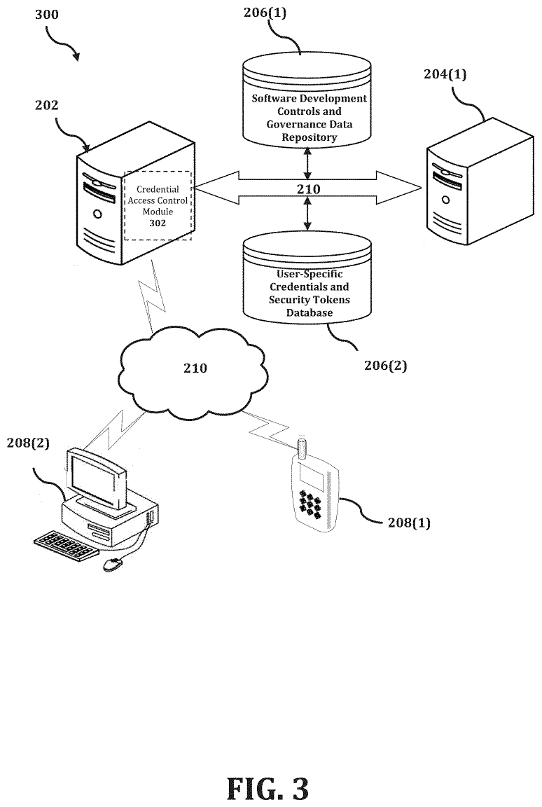

The CAC device 202 is described and shown in FIG. 3 as including a credential access control module 302, although it may include other rules, policies, modules, databases, or applications, for example. As will be described below, the credential access control module 302 is configured to implement a method for controlling access to a security credential in a continuous integration/continuous deployment (CI/CD) pipeline in a manner designed to ensure secure operations while optimizing agility and efficiency in an automated, efficient, scalable, and reliable manner.

An exemplary process 300 for implementing a method for controlling access to a security credential in a CI/CD pipeline in a manner designed to ensure secure operations while optimizing agility and efficiency by utilizing the network environment of FIG. 2 is shown as being executed in FIG. 3. Specifically, a first client device 208(1) and a second client device 208(2) are illustrated as being in communication with CAC device 202. In this regard, the first client device 208(1) and the second client device 208(2) may be “clients” of the CAC device 202 and are described herein as such. Nevertheless, it is to be known and understood that the first client device 208(1) and/or the second client device 208(2) need not necessarily be “clients” of the CAC device 202, or any entity described in association therewith herein. Any additional or alternative relationship may exist between either or both of the first client device 208(1) and the second client device 208(2) and the CAC device 202, or no relationship may exist.

Further, CAC device 202 is illustrated as being able to access a software development controls and governance data repository 206(1) and a user-specific credentials and security tokens database 206(2). The credential access control module 302 may be configured to access these databases for implementing a method for controlling access to a security credential in a CT/CD pipeline in a manner designed to ensure secure operations while optimizing agility and efficiency.

The first client device 208(1) may be, for example, a smart phone. Of course, the first client device 208(1) may be any additional device described herein. The second client device 208(2) may be, for example, a personal computer (PC). Of course, the second client device 208(2) may also be any additional device described herein.

The process may be executed via the communication network(s) 210, which may comprise plural networks as described above. For example, in an exemplary embodiment, either or both of the first client device 208(1) and the second client device 208(2) may communicate with the CAC device 202 via broadband or cellular communication. Of course, these embodiments are merely exemplary and are not limiting or exhaustive.

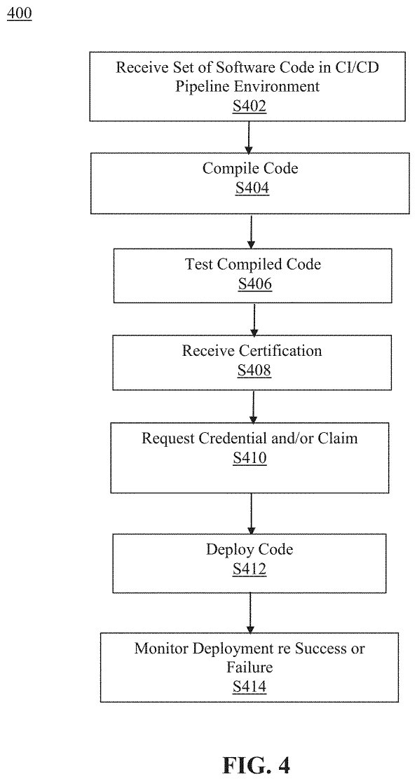

Upon being started, the credential access control module 302 executes a process for controlling access to a security credential in a CI/CD pipeline in a manner designed to ensure secure operations while optimizing agility and efficiency. An exemplary process for controlling access to a security credential in a CI/CD pipeline in a manner designed to ensure secure operations while optimizing agility and efficiency is generally indicated at flowchart 400 in FIG. 4.

In the process 400 of FIG. 4, at step S402, the credential access control module 302 receives a set of software code. In an exemplary embodiment, the software code is being developed in a continuous integration/continuous deployment (CI/CD) pipeline environment.

At step S404, the credential access control module 302 may compile the received set of software code, and then, at step S406, the compiled code is tested. For some languages, such as Java or C++, the code is compiled; for some other languages, such as JavaScript or Python, compiling may not be performed. In an exemplary embodiment, the credential access control module 302 may subject the code to a unit test designed to determine whether the code successfully performs a predetermined function. The credential access control module 302 may subject the code to a regulatory test designed to determine whether the code complies with a predetermined governmental rule or regulation.

Alternatively, or in addition to other tests, the credential access control module 302 may subject the code to a quality test designed to determine whether the code satisfies a predetermined quality standard that is measurable by using one or more metrics. The metrics may relate to any one or more of stability, performance, unit test coverage, presence of code reviews, lists of tickets (e.g., Jira tickets) that have been implemented in previous changes, size of a release, delta of metric with respect to a previous release, maintainability, and/or any other suitable type of metric.

As another type of testing, the credential access control module 302 may subject the code to a security test designed to determine whether the code complies with a predetermined security standard that relates to protecting the code from external intrusions. This is often referred to as code scanning.

The testing may include deployment to a test environment, with provided credentials or tokens, and only allow production deployment upon completion of testing in a lower environment.

The review of decision to provide the credential may include confirming the time window within which that software deployment is permitted to be performed.

The review of decision to provide the credential may include the result of previous software deployments. In this aspect, a team or code base that has successfully performed deployments without production impacts or roll backs may be trusted to deploy more frequently than teams that lack a successful deployment record.

The review of decision to provide the credential may also include a review other releases currently being performed and wait until there is not a potential conflict or too much concurrent change in the environment.

In an exemplary embodiment, when no automated decision can be made, such as when specific country regulatory requirements that require a human to review are applicable, the credential access control module 302 may escalate to a human workflow based on predefined requirements.

Storage of the results of the individual tests should occur for audit and control purposes such that the rationale for approval is available as an audit log.

The credential may be provided instantly, or may keep the requested deployment pending until such time as the decision to proceed is granted. The decision may be approved, with credential provided; pending, i.e., will be approved, potentially within a specified finite window of time; or rejected.

At step S408, the credential access control module 302 receives a certification that the software code has passed at least one test. In an exemplary embodiment, a separate certification may be received for each test to which the code has been subjected. If any particular test has not been passed, the credential access control module 302 may receive a notification of the failure of the particular test.

At step S410, the credential access control module 302 submits a request for a credential and/or for a claim that proves access to the credential of the identity used to deploy. In an exemplary embodiment, the request is submitted to a credential source in conjunction with the received certification, and the credential is generated based on the certification. The credential may include any one or more of a security token, a key or key pair, a signed object, such as a certificate, and/or any other suitable type of credential, i.e., a cryptographic proof or token form that would be required to gain access to deploy the software code to production or any other controlled environment, or to gain access to modify the configuration of a controlled environment.

In an exemplary embodiment, the claim acts as an authorization to use the credential even when the credential itself is stored at the credential source. In this aspect, instead of providing a credential that could be reused, an OpenID Connect (OIDC) or OAuth compliant claim may be provided in order to prove access to the credential. In this scenario, the resultant claim may be distributed instead of the actual credential.

At step S412, the credential access control module 302 deploys the code in a predetermined destination. In an exemplary embodiment, the predetermined destination may be an application programming interface (API), which may be administered by a commercial entity.

At step S414, the credential access control module 302 monitors the success or failure of the deployment to production, in order to ascertain whether the deployment is successful or requires a rollback.

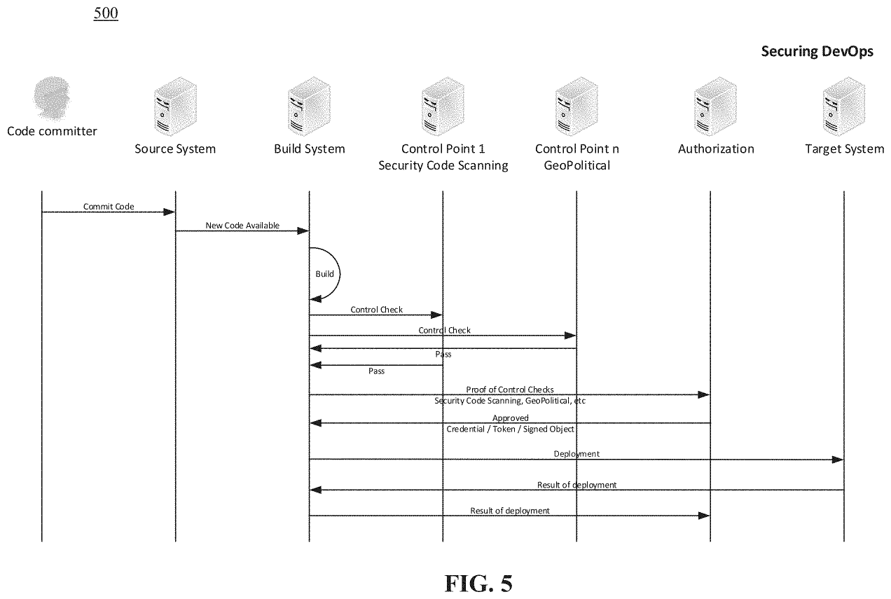

FIG. 5 is a diagram 500 that illustrates a sequence of data flows during a code deployment process, in accordance with an exemplary embodiment. As illustrated in FIG. 5, in a first data flow, a user (illustrated as “Code committer”) commits a first set of software code to a source system (such as, for example, Git), which then notifies a build system that a new set of code is available in a second data flow. In a third data flow, the build system compiles the newly received code.

When the new code has been compiled, the code is then ready for testing. In a fourth data flow, the build system submits the compiled code to a first control point that is configured for security code scanning, and in a fifth data flow, the build system submits that compiled code to a second control point that is configured for geopolitical testing. In a sixth data flow, when the second control point determines that the code has passed an applicable test, a certification that indicates passage of the test is transmitted to the build system. Similarly, in a seventh data flow, when the first control point determines that the code has passed an applicable test, a certification thereof is transmitted to the build system.

In an eighth data flow, the build system submits a request for a credential to a credential source (illustrated as “Authorization”), together with all received certifications, which act as proof that the code has passed the applicable tests. In a ninth data flow, the credential source transmits the requested credential to the build system. In an exemplary embodiment, the credential may include any one or more of a security token, a key, and a signed object. Alternatively, the credential source may provide a claim that proves that the credential has been created, and the claim may serve as an authorization to use the credential.

In a tenth data flow, the build system deploys the code to a target system. In an eleventh data flow, the target system provides a result of the deployment, i.e., whether the deployment has been successful or whether a rollback may be required, to the build system, and then, in a twelfth data flow, the build system communicates the result of the deployment to the credential source.

Accordingly, with this technology, an optimized process for implementing methods and systems for controlling access to a security credential in a CI/CD pipeline in a manner designed to ensure secure operations while optimizing agility and efficiency is provided.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed, rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method for controlling access to a security credential, the method being implemented by at least one processor, the method comprising:
receiving, by the at least one processor from a user, a first set of software code;
testing, by the at least one processor, the first set of code;
receiving, by the at least one processor, a certification that the first set of code has passed at least one test;
requesting, by the at least one processor from a credential source, at least one from among a credential that indicates that the certification has been received and an authorization to use the credential; and
when the at least one from among the credential and the authorization to use the credential has been received, deploying, by the at least one processor, the first set of software code to a predetermined destination.

2. The method of claim 1, wherein the method is implemented in a continuous integration/continuous deployment (CI/CD) pipeline environment.

3. The method of claim 1, wherein the testing comprises subjecting the first set of software code to a unit test designed to determine whether the first set of software successfully performs a predetermined function.

4. The method of claim 1, wherein the testing comprises subjecting the first set of software code to a regulatory test designed to determine whether the first set of software complies with a predetermined governmental regulation.

5. The method of claim 1, wherein the testing comprises subjecting the first set of software code to a quality test designed to determine whether the first set of software satisfies a predetermined quality standard that is measurable by using at least one metric.

6. The method of claim 1, wherein the testing comprises subjecting the first set of software code to a security test designed to determine whether the first set of software complies with a predetermined security standard that relates to protecting the first set of software code from an external intrusion.

7. The method of claim 1, wherein the credential includes at least one from among a security token, a key, and a signed object.

8. The method of claim 1, wherein the authorization to use the credential includes a claim that proves that the user has access to the credential.

9. The method of claim 1, wherein the predetermined destination comprises an application programming interface (API).

10. A computing apparatus for controlling access to a security credential, the computing apparatus comprising:
a processor;
a memory; and
a communication interface coupled to each of the processor and the memory,
wherein the processor is configured to:
receive, from a user, a first set of software code;
test the first set of code;
receive a certification that the first set of code has passed at least one test;
request, from a credential source, at least one from among a credential that indicates that the certification has been received and an authorization to use the credential; and
when the at least one from among the credential and the authorization to use the credential has been received, deploy the first set of software code to a predetermined destination.

11. The computing apparatus of claim 10, wherein the processor is further configured to perform each of the receiving of the first set of software code, the testing, the receiving of the certification, the requesting, and the deploying in a continuous integration/continuous deployment (CI/CD) pipeline environment.

12. The computing apparatus of claim 10, wherein the processor is further configured to subject the first set of software code to a unit test designed to determine whether the first set of software successfully performs a predetermined function.

13. The computing apparatus of claim 10, wherein the processor is further configured to subject the first set of software code to a regulatory test designed to determine whether the first set of software complies with a predetermined governmental regulation.

14. The computing apparatus of claim 10, wherein the processor is further configured to subject the first set of software code to a quality test designed to determine whether the first set of software satisfies a predetermined quality standard that is measurable by using at least one metric.

15. The computing apparatus of claim 10, wherein the processor is further configured to subject the first set of software code to a security test designed to determine whether the first set of software complies with a predetermined security standard that relates to protecting the first set of software code from an external intrusion.

16. The computing apparatus of claim 10, wherein the credential includes at least one from among a security token, a key, and a signed object.

17. The computing apparatus of claim 10, wherein the authorization to use the credential includes a claim that proves that the user has access to the credential.

18. The computing apparatus of claim 10, wherein the predetermined destination comprises an application programming interface (API).

19. A non-transitory computer readable storage medium storing instructions for controlling access to a security credential, the storage medium comprising executable code which, when executed by a processor, causes the processor to:
receive, from a user, a first set of software code;
test the first set of code;
receive a certification that the first set of code has passed at least one test;
request, from a credential source, at least one from among a credential that indicates that the certification has been received and an authorization to use the credential; and
when the at least one from among the credential and the authorization to use the credential has been received, deploy the first set of software code to a predetermined destination.

20. The storage medium of claim 19, wherein the processor is further configured to perform each of the receiving of the first set of software code, the testing, the receiving of the certification, the requesting, and the deploying in a continuous integration/continuous deployment (CI/CD) pipeline environment.
